(19) United States
(12) Patent Application Publication
(10) Pub. No.: US 2014/0301089 A1
(43) Pub. Date: Oct. 9, 2014

(54) MODULE HOLDER AND HEAT SINK, PARTICULARLY FOR LED MODULES AND THE LIKE

(71) Applicant: A.A.G. STUCCHI S.R.L., Olginate (IT)

(72) Inventor: Antonietta STUCCHI, Olginate (IT)

(73) Assignee: A.A.G. STUCCHI S.R.L., Olginate (IT)

(21) Appl. No.: 14/357,811

(22) PCT Filed: Oct. 19, 2012
(86) PCT No.: PCT/EP2012/070784

§ 371 Date: May 13, 2014

(30) Foreign Application Priority Data
Nov. 14, 2011 (IT) MI2011A002061

(51) Int. Cl. F21V 29/00; F21V 17/14

(52) U.S. Cl. CPC F21V 29/22; F21V 17/14
USPC 362/382

(57) ABSTRACT

A module holder and heat sink, particularly for LED modules, comprising a module holder body which is adapted to be coupled to a heat sink with the interposition of a thermal interface material, the module holder being provided with holes for coupling to the heat sink, rivets being provided for insertion in the holes with the interposition of springs, elements being adapted to allow the coupling by interference of the module holder with the heat sink, such elements being adapted to enable the engagement of the rivets by way of the rotation or translational motion of the module holder with respect to the heat sink, without the use of fixing screws.

The present invention relates to a module holder and heat sink, particularly for LED modules and the like.

More specifically, the invention relates to a module holder or lamp holder that is very simple to mount on the heat sink.

As is known, lighting apparatuses, which comprise both LED lamps and LED modules, are provided with a lamp holder or module holder which is designed to be fixed to the heat sink. The LED module has, on the face thereof which is designed to come into contact with the heat sink, a so-called TIM or thermal interface material, which must ensure a correct transmission of heat from the module to the heat sink, since the LEDs inside the module must never exceed a certain temperature.

In substance, thus, the lamp holder or module holder (hereinafter referred to only as module holder) must ensure that there is a good and long-lasting pressure between the TIM and the heat sink, that the module itself has an adequate mechanical strength and, finally, if required, that there is an electrical contact between the power supply circuit and the LED module.

Conventional module holders for LED modules are currently provided by fixing the module holder to the heat sink by way of screws which are provided with springs that make it possible to maintain, once screwed, a correct compression between the module holder and the heat sink.

To this end, the module holder is provided with holes into which fixing screws are inserted which are screwed into holes provided in the heat sink, to which the module holder is to be fixed. This operation takes time and requires care to be taken with how the screws are screwed, and with the screwing force, so as to prevent deformations which can compromise the operation of the LED module system/module holder.

Solutions are available in which for example a rivet is inserted in advance into the hole of the module holder and keeps the spring stationary and in which the screw is then inserted which will then be screwed into the threaded holes provided on the upper surface of the heat sink.

However, as said, the solution explained above implies the use of a screwdriver and of screws for fixing the module holder to the corresponding heat sink.

The aim of the present invention is to provide a module holder, particularly for LED lamps and the like, in which the fixing of the above mentioned module holder to the heat sink can be carried out without using screws or a screwdriver.

Within this aim, an object of the present invention is to provide a module holder, particularly for LED lamps, modules and the like, in which the fixing of the module holder always occurs with the correct pressure, thus freeing the fixing operation from possible differences in tightening torque of the screws which are conventionally used to fix the module holder to the heat sink.

Another object of the present invention is to provide a tool that is adapted to fix the module holder to the heat sink, thus substituting for a screwdriver in its function.

Another object of the present invention is to provide a module holder, particularly for LED lamps, modules and the like (hereinafter referred to only as modules), that is highly reliable, easily and practically implemented and low cost.

This aim and these and other objects which will become better apparent hereinafter are achieved by a module holder and heat sink, particularly for LED modules and the like, comprising a module holder body which is adapted to be coupled to the heat sink with the interposition of a thermal interface material, said module holder being provided with holes for coupling to said heat sink, rivets being provided for insertion in said holes with the interposition of springs, characterized in that it comprises means adapted to allow the coupling by interference of said module holder with said heat sink, said means being adapted to enable the engagement of said rivets by way of the rotation or translational motion of said module holder with respect to said heat sink, without the use of fixing screws.

Further characteristics and advantages of the invention will become better apparent from the description of some preferred, but not exclusive, embodiments of the module holder according to the present invention, which are illustrated by way of non-limiting example in the accompanying drawings, wherein:

FIG. 1 is an exploded perspective view of the module holder with associated heat sink according to the present invention;

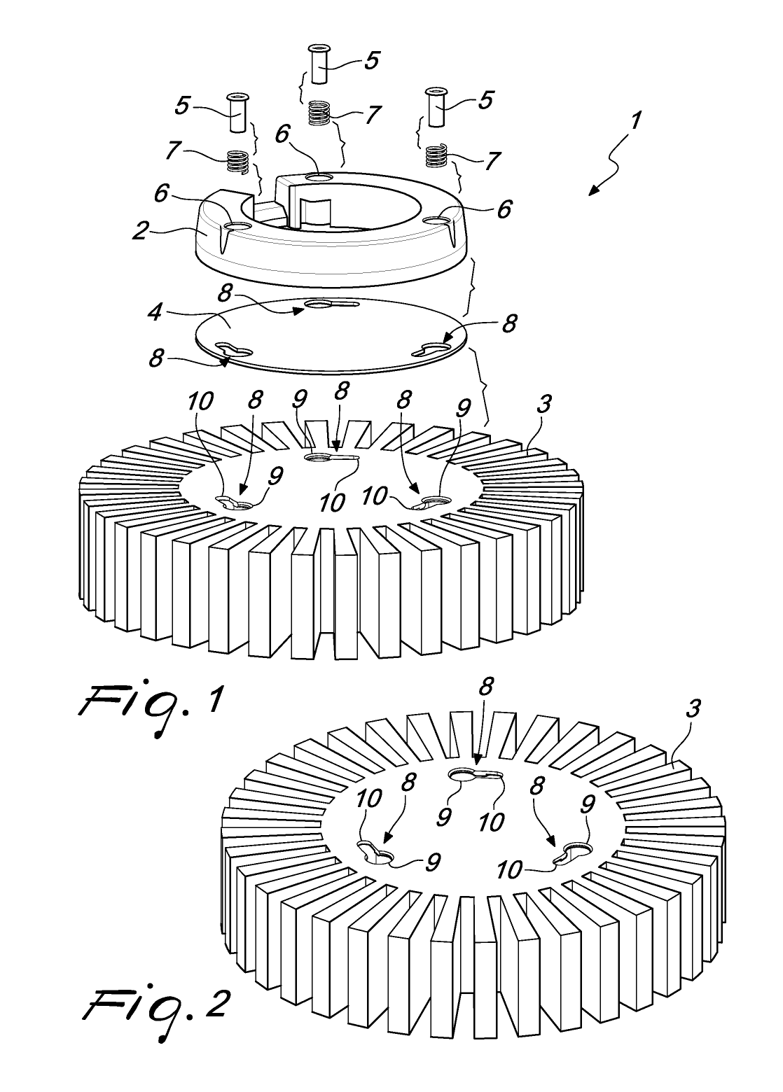

FIG. 2 is a perspective view of the heat sink used with the module holder according to the invention;

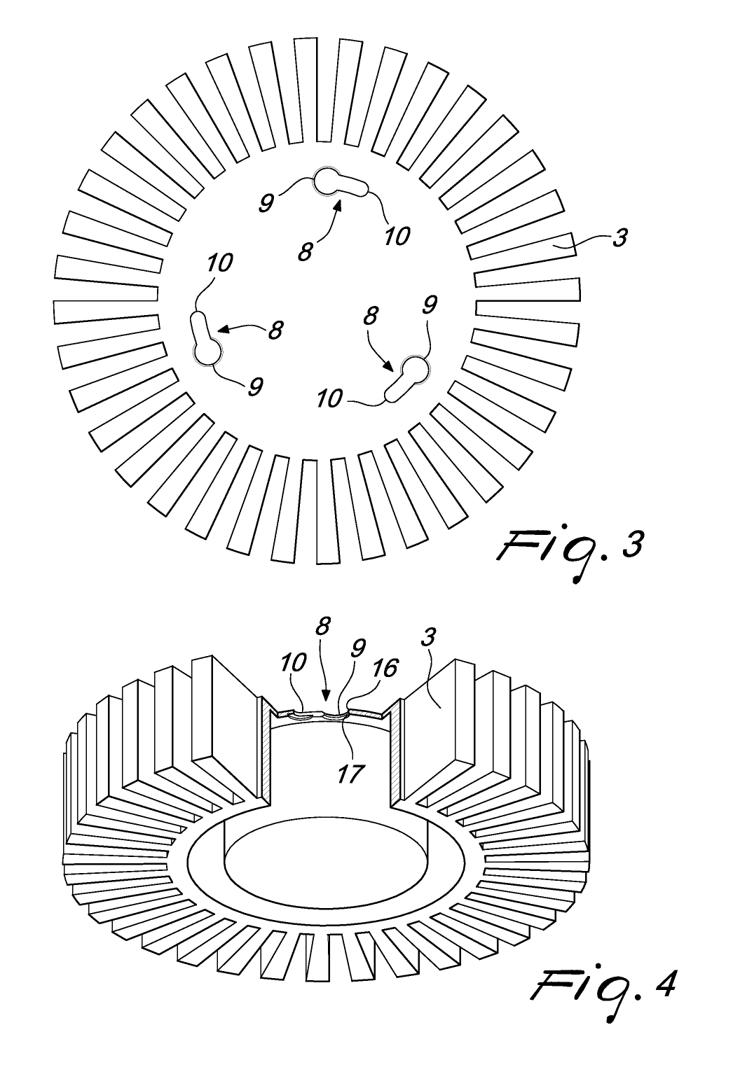

FIG. 3 is a plan view from above of the heat sink in FIG. 2;

FIG. 4 is a partially sectional perspective view from below of the heat sink in FIGS. 2 and 3;

FIG. 5 is a partially sectional perspective view of the coupling between the module holder and the heat sink;

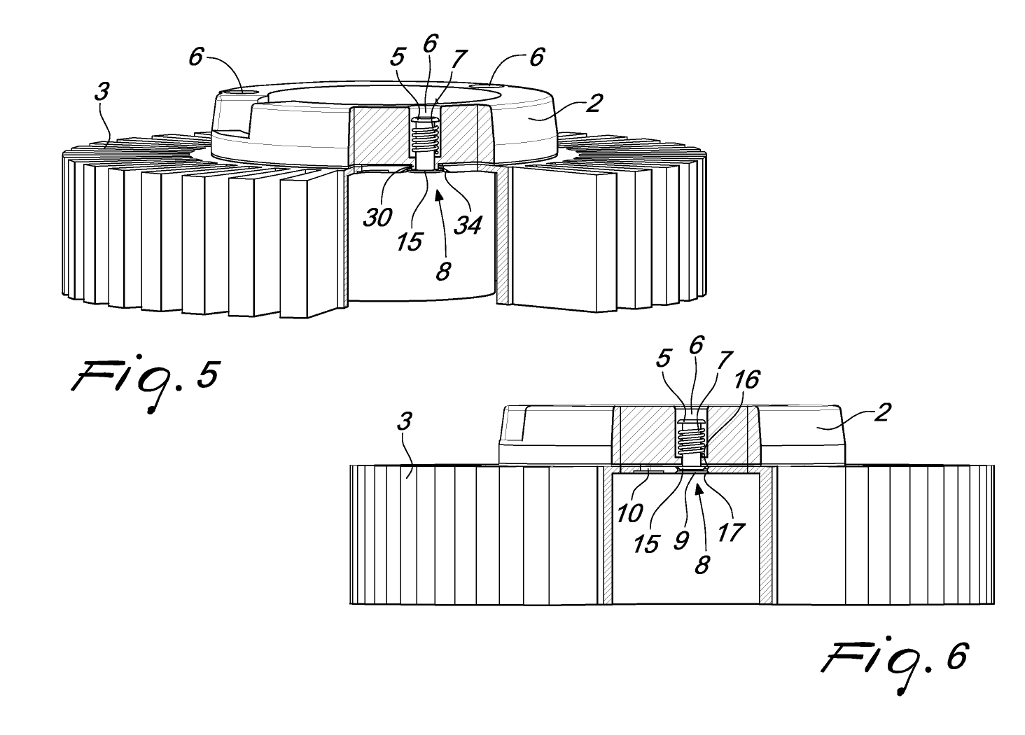

FIG. 6 is a partially sectional front elevation view of the coupling between the module holder and the heat sink;

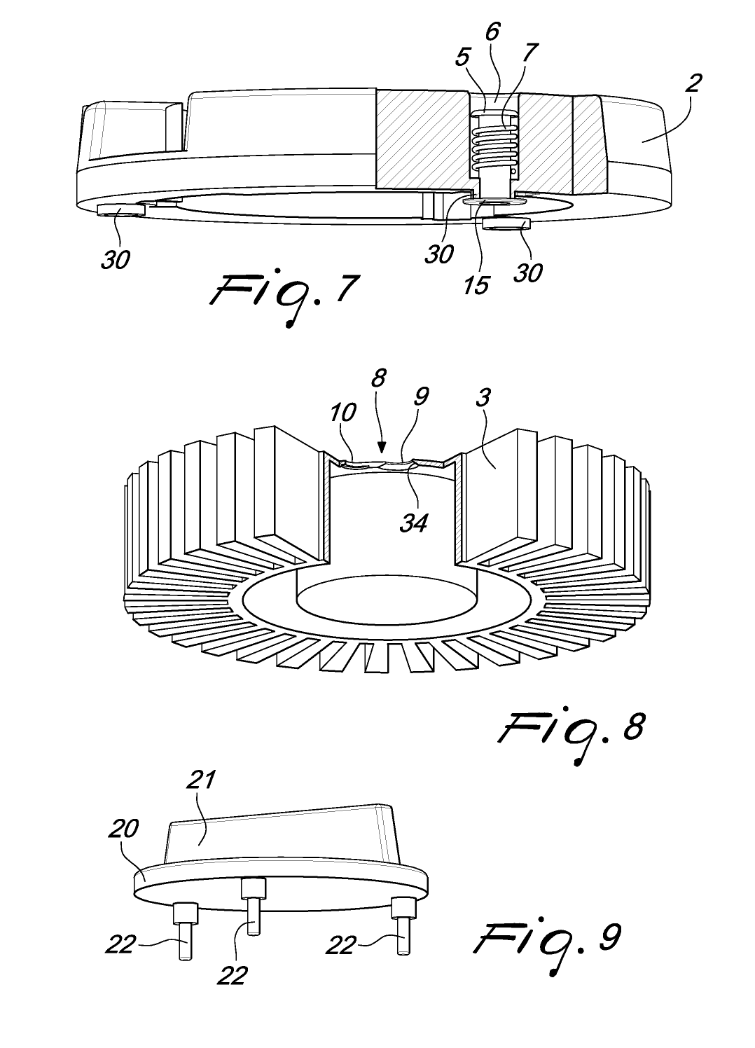

FIG. 7 is a partially sectional perspective view of a second embodiment of the module holder according to the present invention, which does not require a tool for mounting and locking;

FIG. 8 is a partially sectional perspective view from below of the heat sink adapted to be used with the module holder in FIG. 7;

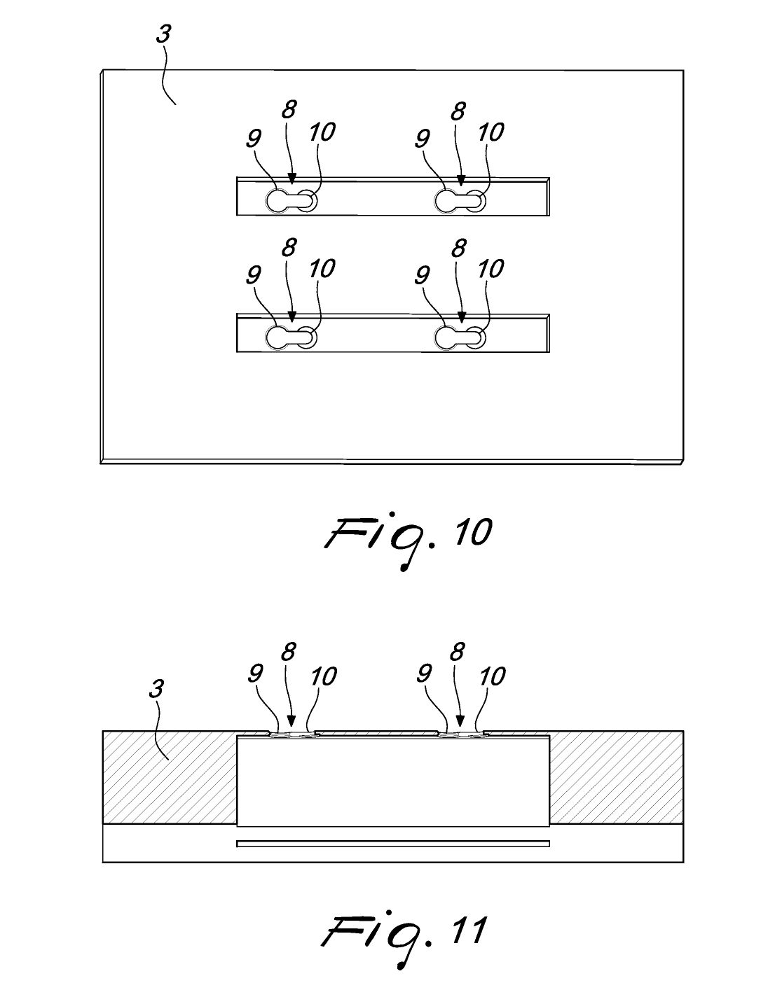

FIG. 9 is a perspective view of a tool that is adapted to be used for locking the module holder according to the invention to the corresponding heat sink;

FIG. 10 is a view of a third embodiment of the heat sink element adapted to be connected with the module holder, rectangular or the like in shape, according to the invention, with or without the use of a tool for mounting and locking;

FIG. 11 is a partially sectional view of the heat sink shown in FIG. 10;

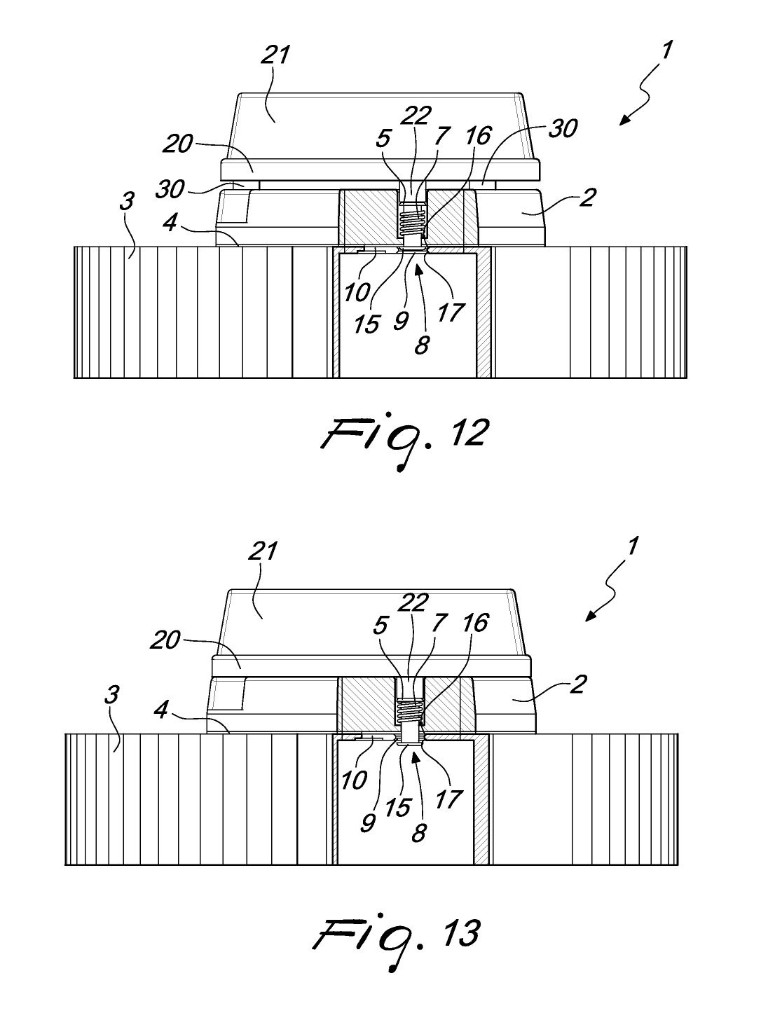

FIG. 12 is a partially sectional view of a first step of using the tool shown in FIG. 9 in order to mate the module holder to the heat sink;

FIG. 13 is a partially sectional view of a second step of using the tool shown in FIG. 9;

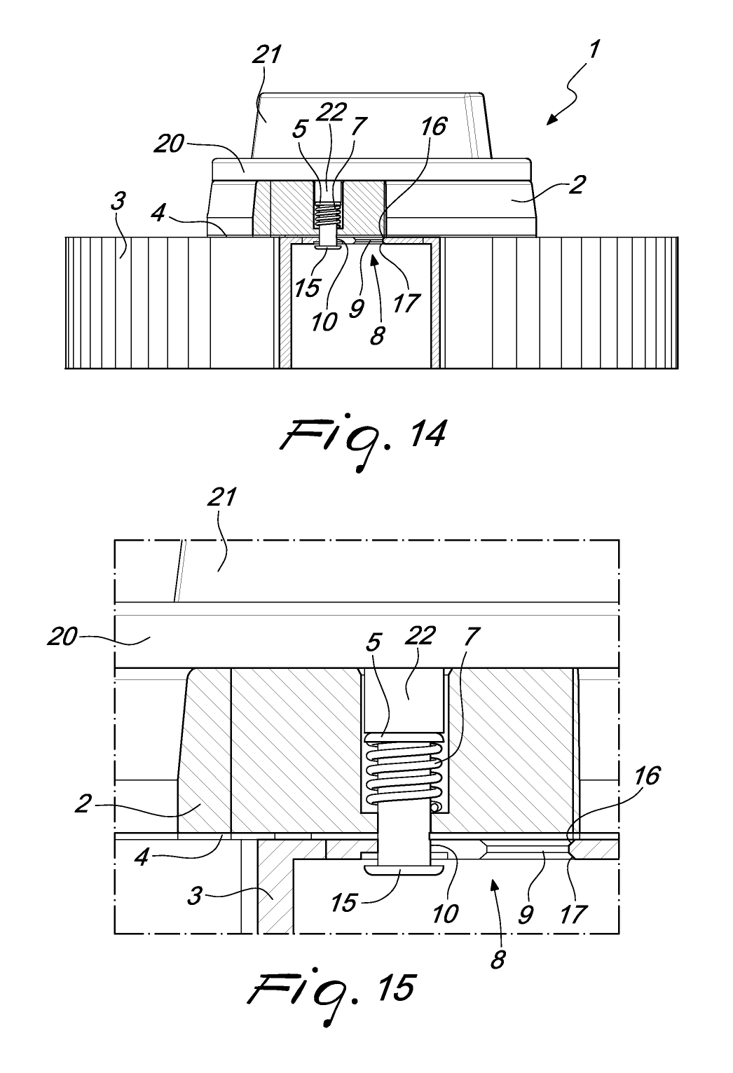

FIG. 14 is a partially sectional view of a third step of using the tool shown in FIG. 9 in order to lock the module holder to the corresponding heat sink;

FIG. 15 is a partially sectional view of an enlarged detail of FIG. 14 just before release in order to arrive at the locking position;

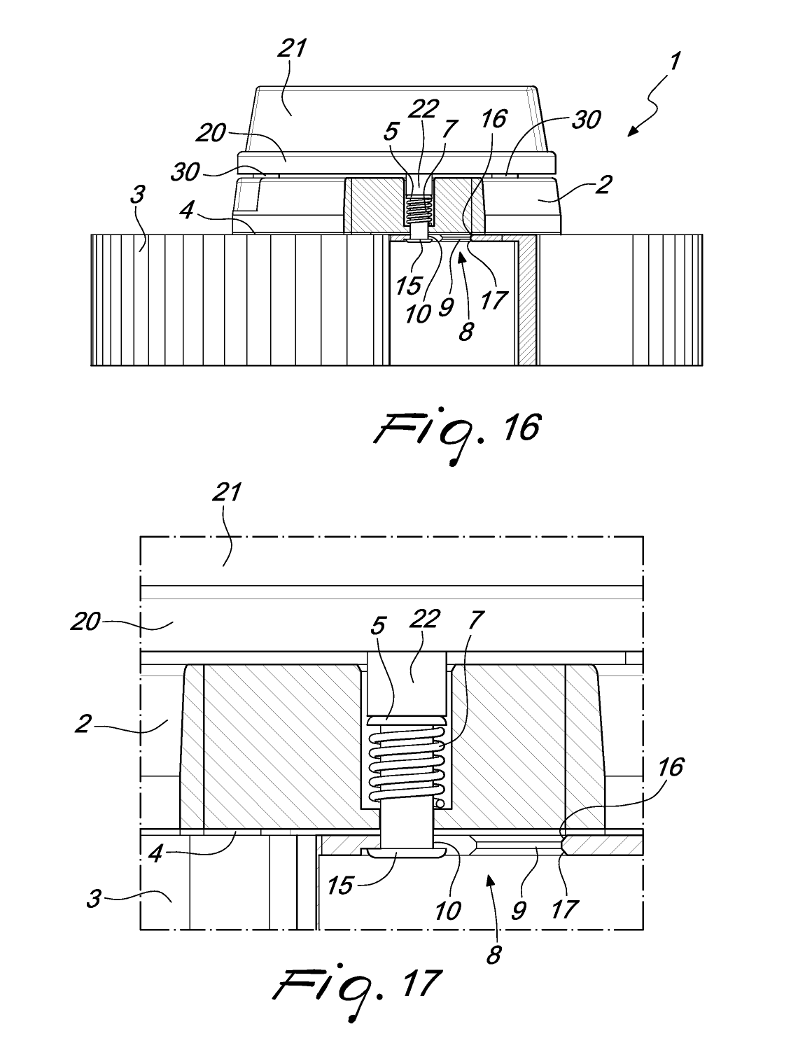

FIG. 16 is a partially sectional view of the final step of locking of the module holder to the heat sink; and

FIG. 17 is a partially sectional view of an enlarged detail of FIG. 16.

With reference to the figures, the module holder with heat sink according to the invention, generally designated by the reference numeral 1, comprises a module holder 2 which is adapted to be coupled to a heat sink 3 with the interposition of a thermal interface material, for example provided as a disk-like element 4 or as a thermal grease.

The coupling between the module holder or lamp holder 2 and the heat sink 3 occurs by way of means of coupling by mechanical interference which are present on the module holder, without the use of fastening elements such as screws and the like, and without needing to use a screwdriver.

In particular, the coupling between the module holder 2 and the heat sink 3 occurs by way of coupling between rivets 5 which are adapted to be inserted into holes 6 in the module holder, inside springs 7, with the rivets 5 mating, with the head 15 after the upsetting operation, on the upper surface of the heat sink 3, in slots 8, which are shaped to have an enlarged portion 9 connected to a portion of smaller size 10.

The slots 8 are similarly provided in the thermal interface material 4, so that the disk-like element 4 can be coupled in advance to the module holder 2, again using the rivets 5 which are inserted into the holes 6 of the module holder, and once the module holder 2 and the disk-like element 4 (TIM, i.e. thermal interface material) have been coupled, the module holder 2 and disk-like element 4 coupled together can be coupled in turn to the heat sink 3, by proceeding to insert the head 15 of the rivets 5 that protrudes below the disk-like element 4, thus holding disk-like element 4 and module holder 2 together, into the holes or slots 8 provided on the surface of the heat sink 3.

The mating between the head 15 of the rivets 5 which protrudes in a position under the disk-like element 4 occurs by inserting the head, which is designated in the figures by the reference numeral 15, into the enlarged portion 9 of the slot 8 and then, for a circular heat sink 3, as shown for example in FIGS. 1, 2 and 3, the module holder 2, with the disk-like element 4 coupled and with rivets 5 inserted in the slots 8 of the heat sink 3, is rotated so as to bring the head of the rivets 5 to the narrow portion 10 of the slot 8, thus bringing the module holder 2 into position on the heat sink 3, without the use of screwdrivers or the like.

Conveniently, in order to ensure the insertion of the head 15 of the rivets 5 into the holes 8 of the heat sink 3, such holes are conveniently contoured, as illustrated by FIG. 4; the hole 8 has, at the portion 9 of the hole having a larger diameter, a greater thickness than the thickness of the portion of hole 10 having a smaller diameter.

Looking at the heat sink from the rear, as indicated in FIG. 4, the portion of the circular sector with smaller diameter is identical to the diameter of the bigger hole.

This difference in thickness acts as a holdback when the module holder 2 and the surface of the rivet are left in the inactive position. In this manner the head of the rivet can no longer come out from its seat when it is subjected to movement in the opposite direction to that of insertion.

Conveniently, in order to ensure the insertion of the head 15 of the rivet 5 into the portion 9 of the hole, such portion is provided with inclined planes 16 and 17 which are adapted to allow the insertion of the head 15 of the rivet 5.

The embodiment just described involves, for the coupling between module holder 2 and heat sink 3, the use of an adapted tool, shown in FIG. 9, which is constituted by a disk-like element 20 from which protrudes, vertically, a portion of handle 21, and, below the element 20, pins 22 being provided which are adapted to be inserted into the holes 6 of the module holder 2 so as to compress the rivets 5, as will be better described hereinafter.

In variations of embodiment shown in FIGS. 10 and 11, for example, the heat sink 3 can have a rectangular shape, still with the slots or holes 8 shaped as described above, or it can be square. In this case, the coupling between the module holder 2 and the heat sink 3 does not occur by way of rotation, but rather by way of a translational motion of the heads 15 of the rivets 5 in the holes 8 provided on the upper surface of the heat sink 3.

In yet another different embodiment, in which the coupling between the module holder 2 and the heat sink 3 can occur without the use of the tool shown in FIG. 9, the module holder 2 is contoured so as to provide, at the lower surface thereof, hubs 30 in which the rivet 5 is placed with the spring 7. In this manner the head 15 of the rivet 5 is positioned under the plane of the hubs 30. In this case, the heat sink 3 still has the holes 8, which however have only one inclined plane 34 at the lower part of the hole 8 in order to facilitate the sliding of the head 15 of the rivet 5 which, kept at a height that makes it possible to fit the inclined plane 34, exits from the hub 30 which is present at the lower surface of the module holder 2.

In this position the module holder 2 can rotate manually, without the use of an additional rotation tool, fitting into the inclined plane 34, in order to arrive at the position of operation that prevents the exit thereof

Operation of the module holder for fixing without screws to the heat sink according to the invention is as follows.

First it should be noted that the rivets 5 and the springs 7 of the module holder 2 have been elongated with respect to those used in module holders with screw-fixing to the heat sink, so that the head of the rivet can exit from the lower surface of the module holder 2 and also from the surface of the disk-like element 4 in order to enable the centering of the wider portion 9 of the contoured hole 8 of the heat sink 3.

In this manner, the disk-like element 4 can be supplied already fixed to the module holder 2. This enables a rapid and simplified installation.

Thus, once the module holder 2 is fixed to the disk-like element 4, the module holder 2 is rested on the surface of the heat sink 3 and the heads 15 are centered of the rivets 5 that exit from the lower surface of the module holder 2 in the corresponding holes 8, and in particular at the portion 9 of the hole 8 that is present on the surface of the heat sink 3.

At this point, in the first embodiment, the pins 22 of the mounting tool are inserted into the fixing holes 6 of the module holder 2, resting the end on the upper head of the rivets 5.

At this point, the utensil or tool is pushed downward so that the rivets 5 are pushed inside the bigger hole 9 of the contoured hole 8 and at the same time the springs 7 are compressed until the holdback comes into contact with the upper wall of the module holder 2. In this manner it is possible for the head 15 of the rivet 5 to be positioned beyond the thickness of the wall of the heat sink 3.

When the tool has arrived at the holdback position, the tool is rotated and the module holder 2 rotates together with the tool until the terminal position of the portion of the contoured hole is reached, i.e. the portion 10 of the hole with reduced diameter.

The tool or utensil at this point is released, so that the springs 7 will also be released and the head 15 of the rivet 5 enters the circular depression 10 provided in the rear of the horizontal wall of the heat sink 3.

In this manner the spring 7 arrives at the optimal position in order to ensure the correct pressure between the module holder 2 and the heat sink 3 through the disk-like element 4.

When the head 15 of the rivet 5 has entered the circular shape of the hole 8, i.e. at the region 10 of the hole 8, and the rivet 5 has retracted to the position specified under the action of release of the spring 7, it can no longer exit even if the module holder 2 is subjected to a movement contrary to that of insertion (for example if it is subjected to a vibration or when the module holder 2, or the locking ring, must be removed, etc.) since there is a step that prevents its egress.

In the second embodiment, i.e. the embodiment in which the module holder 2 is provided with the hubs 30, the fixing occurs in a similar manner to what has previously been described, with the sole difference that it can be performed directly by hand by the technician, and thus without the use of the tool or utensil.

In practice it has been found that the module holder and the heat sink according to the present invention achieve the intended aim and objects, in that they make it possible to be coupled without the use of screws and thus of a screwdriver, in addition to the fact that they enable the rapid and reliable coupling of the thermal interface material with the module holder, before mating the whole thus obtained with the heat sink.

The module holder, thus conceived, is susceptible of numerous modifications and variations, all of which are within the scope of the appended claims. Moreover, all the details may be substituted by other, technically equivalent elements.

In practice the materials employed, as well as the contingent dimensions and shapes, may be any according to requirements and to the state of the art.

The disclosures in Italian Patent Application No. MI2011A002061 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A module holder and heat sink, particularly for LED modules and the like, comprising a module holder body which is adapted to be coupled to a heat sink with the interposition of a thermal interface material, said module holder being provided with holes for coupling to said heat sink, rivets being provided for insertion in said holes with the interposition of springs, further comprising means which are adapted to allow the coupling by interference of said module holder with said heat sink, said means being adapted to allow the engagement of said rivets by means of the rotation or translational motion of said module holder with respect to said heat sink.

12. The module holder and heat sink according to claim 11, wherein said means adapted to allow coupling between said module holder and said heat sink comprise holes to allow the insertion of said rivets and the locking thereof after rotation or translational motion of the module holder with respect to said heat sink.

13. The module holder and heat sink according to claim 12, wherein said holes are provided on the surface of said heat sink and are constituted by a portion having a larger diameter, which joins with a portion having a smaller diameter for the passage respectively of a head of said rivet and of the shank of said rivet once said module holder is locked to said heat sink.

14. The module holder and heat sink according to claim 13, wherein said holes provided on the surface of said heat sink have two differentiated thicknesses between the portion having a larger diameter and the portion having a smaller diameter.

15. The module holder and heat sink according to claim 12, wherein said thermal interface material is constituted by a disk-like element, which is provided with holes which are similar to the holes provided on the upper surface of said heat sink, for the coupling of said disk-like element to said module holder and the subsequent coupling of said module holder and said disk-like element to said heat sink.

16. The module holder and heat sink according to claim 13, wherein said module holder is provided, at its lower surface, which is adapted to be directed toward said disk-like element and said heat sink, with hubs which are adapted to allow the locking of the heads of the rivets once said rivets have been inserted in said holes provided in the module holder.

17. The module holder and heat sink according to claim 13, wherein said holes provided on the upper surface of the heat sink comprise, at the portion having a larger diameter, at least one inclined plane in order to facilitate the insertion of the head of the rivet.

18. The module holder and heat sink according to claim 11, wherein said heat sink is circular or rectangular or square.

19. The module holder and heat sink according to claim 11, comprising a tool adapted to allow the coupling of said module holder to said heat sink, said tool being provided by a disk-like element, from the lower surface of which pins protrude which are adapted to be inserted in the holes of said module holder.

20. The module holder and heat sink according to claim 16, wherein the head of the rivet inserted in said holes of the module holder is adapted to arrange itself below the plane of said hubs of the module holder.
